(19) United States
(12) Patent Application Publication
(10) Pub. No.: US 2025/0133284 A1
(43) Pub. Date: Apr. 24, 2025

(54) IMAGE PRESENTATION DEVICE, IMAGE PRESENTATION METHOD, AND PROGRAM

(71) Applicant: NIPPON TELEGRAPH AND TELEPHONE CORPORATION, Tokyo (JP)

(72) Inventors: Hideaki IWAMOTO, Tokyo (JP); Hiroshi CHIGIRA, Tokyo (JP); Masafumi SUZUKI, Tokyo (JP); Tatsuya MATSUI, Tokyo (JP); Satoshi SAKUMA, Tokyo (JP)

(73) Assignee: NIPPON TELEGRAPH AND TELEPHONE CORPORATION, Tokyo (JP)

(21) Appl. No.: 18/691,834

(22) PCT Filed: Sep. 17, 2021
(86) PCT No.: PCT/JP2021/034432

§ 371 Date: Mar. 13, 2024

(51) Int. Cl. H04N 23/63; H04N 23/60

(52) U.S. Cl. CPC H04N 23/631; H04N 23/64

(57) ABSTRACT

An image presentation device (1) according to the present invention includes: an image capturing unit (11) configured to capture images of a plurality of users; an image processing unit (12) configured to process the captured images with an effect; and an image combining unit (14) configured to alternately switch between the captured images of the plurality of users and the processed images and to display them on a display device (4).

### TECHNICAL FIELD

The present disclosure relates to an image presentation device, an image presentation method and a program.

### BACKGROUND ART

Conventionally, a theme park often provides a photo souvenir service by which a user can get photos capturing them wearing a mask or riding attractions such as a roller coaster and share with other users for enjoyment. FIG. 10 is a block diagram illustrating a configuration example of a conventional image presentation device. According to the image presentation device 3 illustrated in FIG. 10, an image capturing unit 11 creates a captured image a obtained by capturing a user, an image processing unit 12 creates a processed image b obtained by processing the captured image a with an effect, and an image combining unit 14 creates a combined image d obtained by combining the processed images b of a plurality of users, and presents the combined image d on a display device (display) 4. The effect refers to processing that is performed on an audio or image to add some special effects.

Non Patent Literature 1 describes a souvenir shooting service provided at an attraction, for example, in a theme park or amusement park, in which an image obtained by capturing a user is processed with an effect, and images of a plurality of surrounding users are combined and presented on a display device, such as a large monitor.

Non Patent Literature 2 describes a service of performing processing on a user's image with kumadori makeup for kabuki. Additional services of combining and presenting images of a plurality of surrounding users on a display device such as a large monitor are conceivable.

### CITATION LIST

### Non Patent Literature

Non Patent Literature 1: FUJIFILM Corporation, “Fuji shika shiranai sekai theme park no omoide wo saikou no ichimai ni (in Japanese) (World Known to Only Fuji: Locking up Best Memories of Theme Parks in Souvenir Photos)”, [online], [retrieved on Aug. 26, 2021], Internet <URL: https://sp-jp.fujifilm.com/netprint/shiranai-sekai/sep_2017/>
Non Patent Literature 2: NTT, “Niconico chokaigi 2016 to Japan KABUKI Festival in Las Vegas 2016 nite, kabuki to saishin no ICT gijutsu no yugou wo jitsugen (in Japanese) (Fusion of Kabuki and Latest ICT Technology in Niconico Chokaigi 2016 and Japan KABUKI Festival in Las Vegas 2016)”, [retrieved on Aug. 26, 2021], Internet <URL: https://group.ntt/jp/newsrelease/2016/04/19/160419a.html>

### SUMMARY OF INVENTION

### Technical Problem

However, it would be a burden on users to find an image capturing themselves because accessible images include images of other users.

### Solution to Problem

The present invention is intended to address the problem above, and an object thereof is to reduce a burden on a user to find an image capturing themselves from among a plurality of images by alternately switching between an image processed with an effect and a pre-processing image and presenting them when providing images to the user.

To solve the problem above, an image presentation device according to a first embodiment is an image presentation device for presenting an image of a user, the device including: an image capturing unit configured to capture images of a plurality of users; an image processing unit configured to process the captured images with an effect; and an image combining unit configured to alternately switch between the captured images of the plurality of users and the processed images and to display them on a display device.

To solve the problem above, an image presentation method according to the first embodiment is an image presentation method for presenting an image of a user, the method including: by an image presentation device, capturing images of a plurality of users; processing the captured images with an effect; and alternately switching between the captured images of the plurality of users and the processed images and displaying them on a display device.

To solve the problem above, a program according to the first embodiment causes a computer to function as the image presentation device.

### Advantageous Effects of Invention

A user can easily find out an image capturing themselves from among a plurality of images by alternately switching between an image processed with an effect and a pre-processing image and presenting them.

### BRIEF DESCRIPTION OF DRAWINGS

FIG. 1 is a block diagram illustrating a configuration example of an image presentation device according to a first embodiment.

FIG. 2 is an illustration of an image (captured image) obtained by capturing a user.

FIG. 3 is an illustration of an image (processed image) obtained by processing a captured image with an effect.

FIG. 4 is a schematic diagram illustrating an image (composite image) obtained by synthesizing the captured image and the processed image.

FIG. 5 is a schematic diagram illustrating an image (combined image) obtained by combining composite images of a plurality of users.

FIG. 6 is a flowchart illustrating one example of image presentation method executed by the image presentation device according to the first embodiment.

FIG. 7 is a block diagram illustrating a configuration example of an image presentation device according to a second embodiment.

FIG. 8 is a flowchart illustrating one example of image presentation method executed by the image presentation device according to the second embodiment.

FIG. 9 is a block diagram illustrating a schematic configuration of a computer that functions as the image presentation device.

FIG. 10 is a block diagram illustrating a configuration example of a conventional image presentation device.

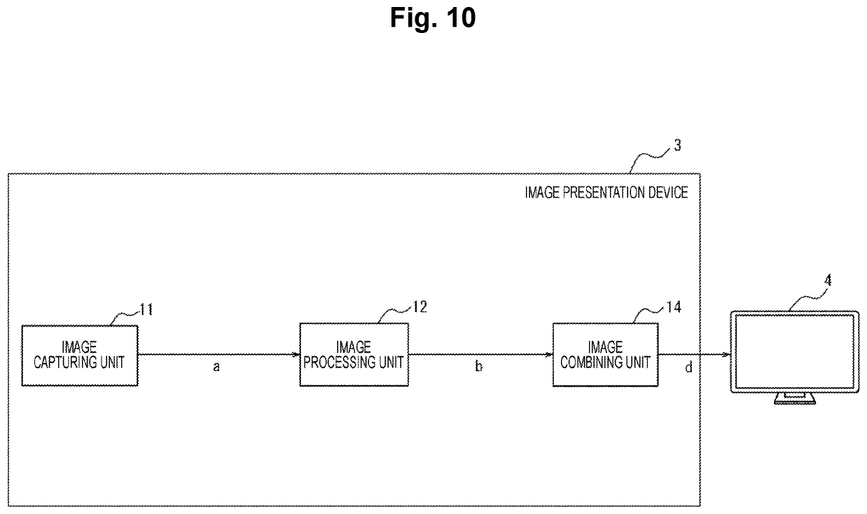

### DESCRIPTION OF EMBODIMENTS

A mode for carrying out the present invention will be described in detail hereinafter with reference to the drawings.

### First Embodiment

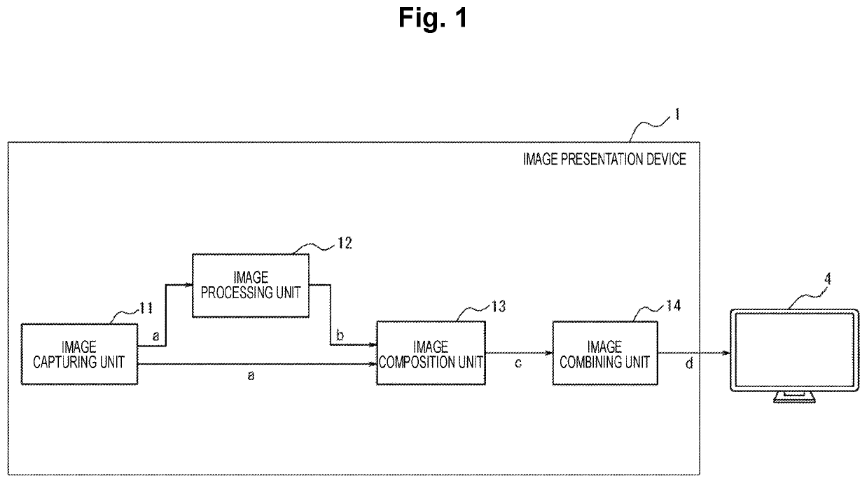

FIG. 1 is a block diagram illustrating a configuration example of an image presentation device according to a first embodiment. An image presentation device 1 illustrated in FIG. 1 includes an image capturing unit 11, an image processing unit 12, an image composition unit 13, and an image combining unit 14. The image presentation device 1 alternately switches between and presents a processed image obtained by processing an image of a user with an effect and a pre-processing image. The image processing unit 12, the image composition unit 13, and the image combining unit 14 constitute a control arithmetic circuit (controller). The control arithmetic circuit may be configured by dedicated hardware such as an application specific integrated circuit (ASIC) or a field-programmable gate array (FPGA), may be configured by a processor, or may be configured to include both dedicated hardware and a processor.

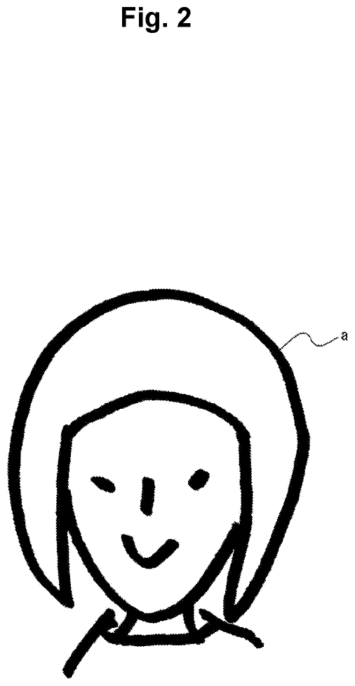

The image capturing unit 11 captures an image of the user. The image capturing unit 11 is a camera. FIG. 2 is an illustration of a captured image (hereinafter referred to as “captured image a” or “a”) obtained by capturing the user. The image capturing unit 11 outputs the captured image a to the image processing unit 12 and the image composition unit 13.

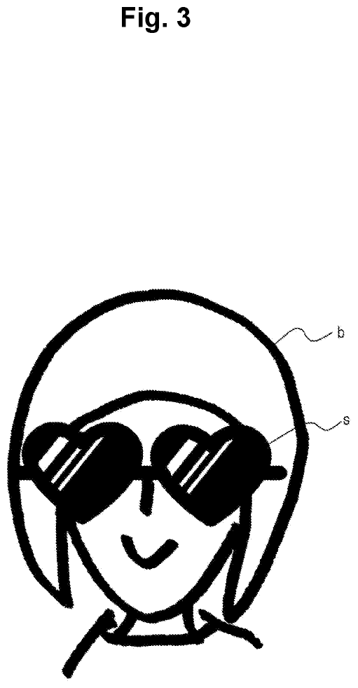

The image processing unit 12 processes the captured image a with an effect. The image processing unit 12 may use the effect provided in advance in the image presentation device 1. Furthermore, in a case where the image presentation device 1 does not include an effect, an effect indicated by an effect image input from an external terminal or an effect image specified by the user may be used. FIG. 3 is an illustration of an image (hereinafter referred to as “processed image b” or “b”) obtained by processing the captured image a with an effect. FIG. 3 illustrates an example in which sunglasses s correspond to the effect image indicating the effect, and the effect image is superimposed on the captured image a as “processing”. The image processing unit 12 outputs the processed image b to the image composition unit 13.

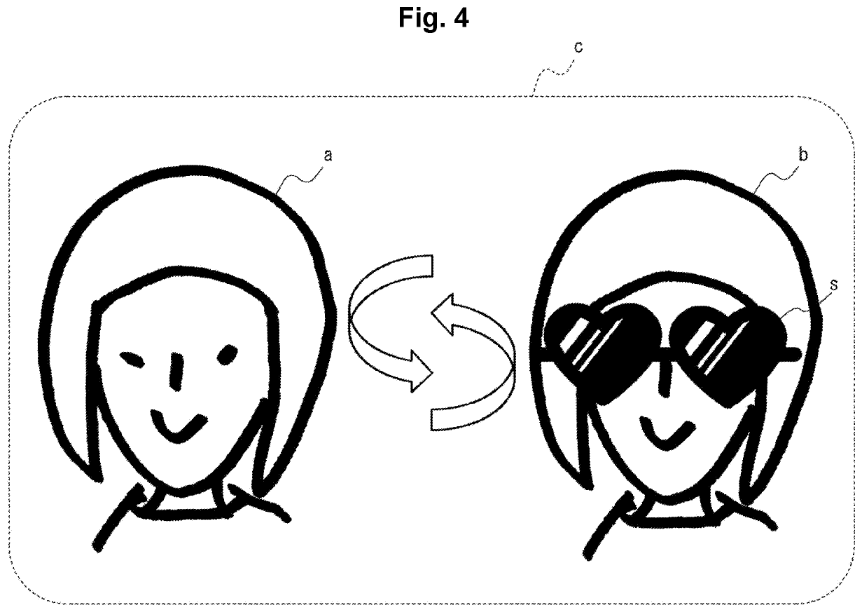

The image composition unit 13 synthesizes the captured image a input from the image capturing unit 11 and the processed image b input from the image processing unit 12. FIG. 4 is a schematic diagram illustrating a composite image (hereinafter referred to as “composite image c” or “c”) obtained by synthesizing the captured image and the processed image. As illustrated in FIG. 4, the composite image c includes the captured image a and the processed image b. The image composition unit 13 may generate the composite image c that alternately switches between and presents the captured image a and the processed image b of the user. For example, the captured image a and the processed image b of the user may be alternately switched between and presented at intervals of several seconds. The image composition unit 13 sequentially outputs the composite image c of each user to the image combining unit 14.

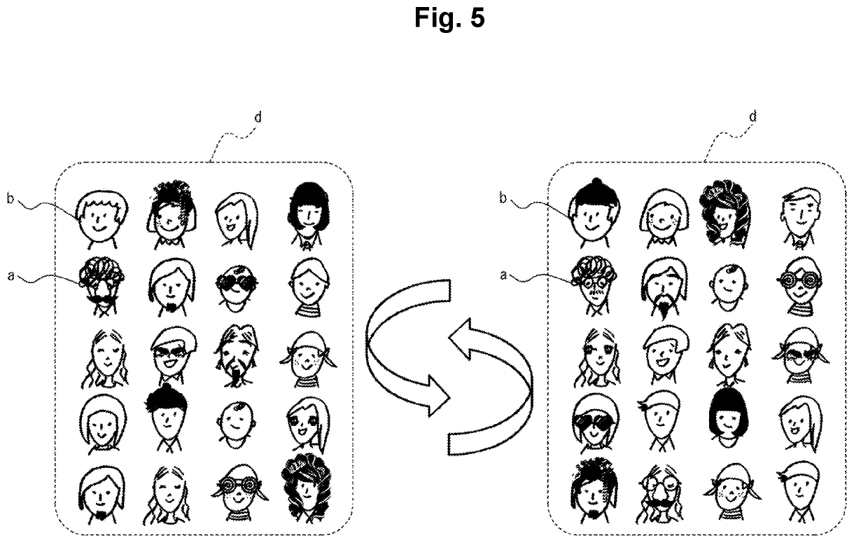

The image combining unit 14 generates an image d obtained by combining the composite images c for the plurality of users sequentially received from the image composition unit 13. FIG. 5 is a schematic diagram illustrating an image (hereinafter referred to as “combined image d” or “d”) obtained by combining the composite images c of the plurality of users. As illustrated in FIG. 5, the image combining unit 14 generates the combined image d in which the captured images a and the processed images b of the plurality of users are alternately switched between and presented for each user. The captured images a and the processed images b of the plurality of users may be alternately switched and presented at intervals of several seconds for each user. There are both the user presented in the captured image a and the user presented in the processed image b in each combined image d. The image combining unit 14 alternately switches the captured images a and the processed images b of the plurality of users and displays them on the display device 4 for each user. For example, the captured images a of the faces of multiple users and the images of faces on which kumadori makeup is superimposed on users may be alternately switched between for each user and displayed on the large monitor. The kumadori makeup corresponds to an effect image for adding an effect (special effect) to the user's face, and the individual image of the face with kumadori makeup corresponds to the processed image b indicating the effect (special effect). The image displayed by alternately switching between the captured images a of users and the processed images b of faces with kumadori makeup corresponds to the combined image d. The large monitor corresponds to the display device 4.

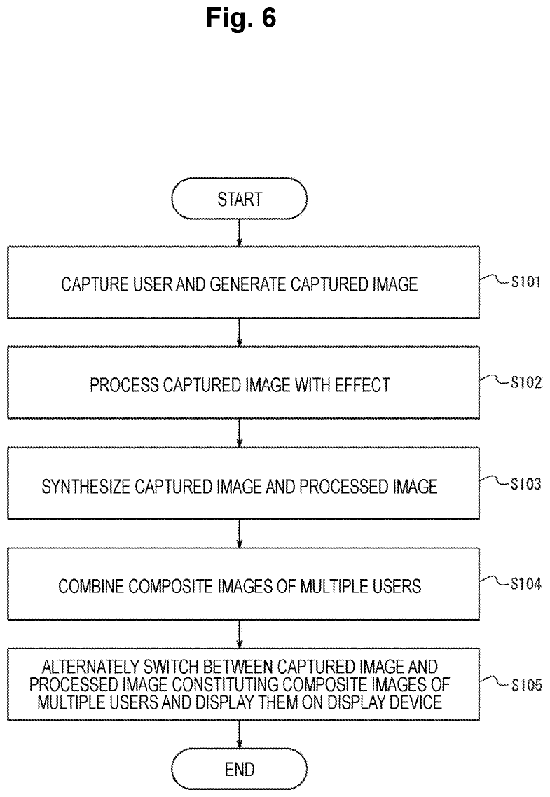

FIG. 6 is a flowchart illustrating one example of image presentation method executed by the image presentation device according to the first embodiment.

In step S101, the image capturing unit 11 captures the user and generates the captured image a.

In step S102, the image processing unit 12 processes the captured image a with the effect.

In step S103, the image composition unit 13 synthesizes the captured image a and the processed image b obtained by processing the captured image a with the effect.

In step S104, the image combining unit 14 combines the composite images c of multiple users.

In step S105, the image combining unit 14 alternately switches between the captured images a and the processed images b constituting the composite images c of multiple users and displays them on the display device 4.

According to the image presentation device 1, the user can easily find out an image capturing themselves from among a plurality of images since an image processed with an effect and a pre-processing image are alternately switched between and presented.

### Second Embodiment

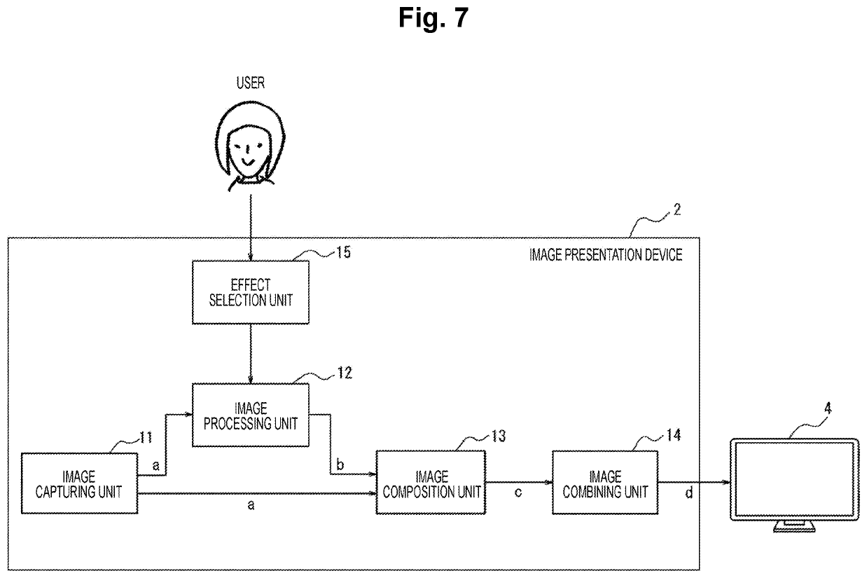

FIG. 7 is a block diagram illustrating a configuration example of an image presentation device according to a second embodiment. An image presentation device 2 illustrated in FIG. 7 includes an image capturing unit 11, an image processing unit 12, an image composition unit 13, an image combining unit 14, and an effect selection unit 15. The image presentation device 2 is different in further including the effect selection unit 15 as compared with the image presentation device 1 according to the first embodiment. The image processing unit 12, the image composition unit 13, the image combining unit 14, and the effect selection unit 15 constitute a control arithmetic circuit (controller). The control arithmetic circuit may be configured by dedicated hardware such as an application specific integrated circuit (ASIC) or a field-programmable gate array (FPGA), may be configured by a processor, or may be configured to include both dedicated hardware and a processor. The same components as those of the first embodiment will be denoted by the same reference signs as those of the first embodiment, and the description thereof will be omitted as appropriate.

The effect selection unit 15 allows the user to select an effect to be used for image processing before capturing the image of the user. The effect selection unit 15 may be connected to an input terminal worked in response to input operations, such as a keyboard or a touchscreen. In such a case, the user selects an effect using the input terminal. The effect selection unit 15 outputs the effect selected by the user to the image processing unit 12. The image processing unit 12 processes a captured image a of the user with the effect selected by the user.

The effect selection unit 15 may generate a plurality of effect images indicating effects (special effects), and output an effect indicated by an effect image selected by the user to the image processing unit 12. The effect selection unit 15 may be connected to a display worked in response to pen inputs. In such a case, the user draws the effect image indicating the effect on the display worked in response to pen inputs. The effect selection unit 15 may be connected to a camera worked in response to image capturing operations. In such a case, the user allows the camera to capture the effect image indicating the effect. Furthermore, the effect selection unit 15 may be connected to a wireless or wired signal receiver. In such a case, the user transmits the effect image edited using image editor on a terminal device, such as a smartphone, tablet or PC, to the signal receiver in a wireless or wired manner from the terminal device. The effect selection unit 15 may receive a plurality of effect images from at least one of the input terminals such as the display, camera, and signal receiver. The effect selection unit 15 outputs the effect indicated by the effect image selected by the user, among several effects respectively indicated by the received effect images, to the image processing unit 12. The image processing unit 12 processes the captured image a of the user with the effect selected by the user using the effect selection unit 15.

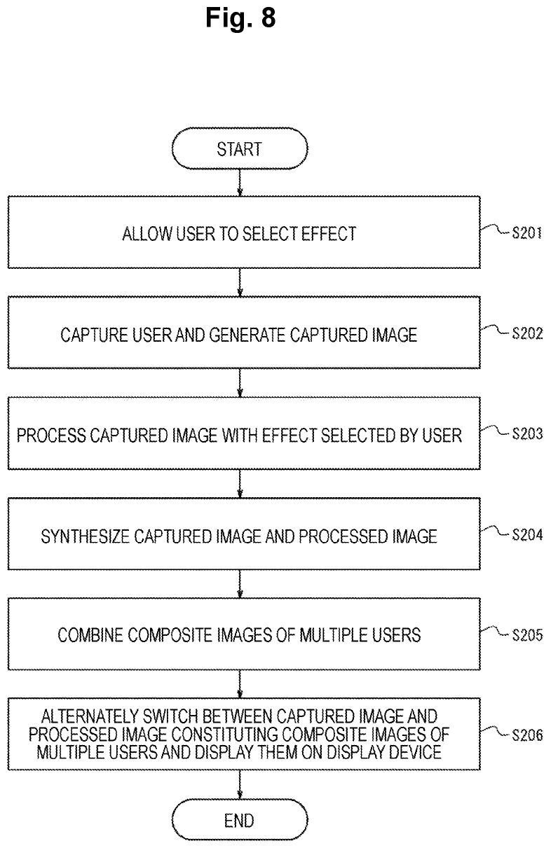

FIG. 8 is a flowchart illustrating one example of image presentation executed by the image presentation device according to the second embodiment.

In step S201, the effect selection unit 15 allows the user to select the effect to be used for image processing of the captured image a before capturing the user.

In step S202, the image capturing unit 11 captures the user and generates the captured image a.

In step S203, the image processing unit 12 processes the captured image a with the effect selected by the user.

In step S204, the image composition unit 13 synthesizes the captured image a and the processed image b obtained by processing the captured image a.

In step S205, the image combining unit 14 combines the composite images c of multiple users.

In step S206, the image combining unit 14 alternately switches between the captured images a and the processed images b constituting the composite images c of multiple users and displays them on the display device 4.

According to the image presentation device 2, the user can easily find out an image capturing themselves based on the effect selected by them or their captured image a before processing, since the image b processed with the effect selected by the user in advance and the pre-processing image a are alternately switched between and presented.

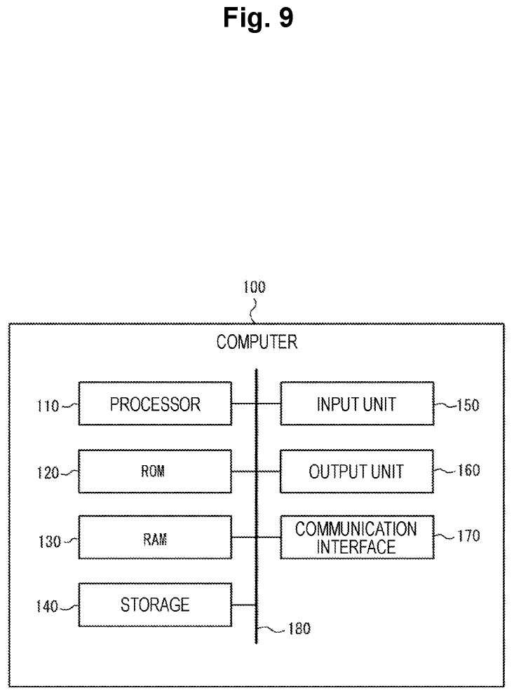

In order to cause the image presentation device 1 and the image presentation device 2 to function, it is also possible to use a computer capable of executing a program command. FIG. 9 is a block diagram illustrating a schematic configuration of a computer that functions as the image presentation device. The computer that functions as the image presentation device 1 and the image presentation device 2 may be, for example, a general-purpose computer, a dedicated computer, a workstation, a personal computer (PC) or an electronic note pad. The program command may be, for example, a program code or code segment for executing a necessary task.

As illustrated in FIG. 9, a computer 100 includes a processor 110, a read only memory (ROM) 120, a random access memory (RAM) 130, and a storage 140 as storage units, an input unit 150, an output unit 160, and a communication interface (I/F) 170. The components are communicably connected to each other via a bus 180.

The ROM 120 stores various programs and various types of data. The RAM 130 temporarily stores a program or data as a working area. The storage 140 is constituted by a hard disk drive (HDD) or a solid state drive (SSD), and stores various programs including an operating system and various types of data. In the present disclosure, a program according to the present disclosure is stored in the ROM 120 or the storage 140.

Specifically, the processor 110 is, for example, a central processing unit (CPU), a micro processing unit (MPU), a graphics processing unit (GPU), a digital signal processor (DSP), or a system-on-a-chip (SoC), and may be constituted by the same or different types of plurality of processors. The processor 110 reads a program from the ROM 120 or the storage 140 and executes the program by using the RAM 130 as a working area to perform control of each of the components described above and various types of arithmetic processing. At least some of those processes may be implemented by hardware.

The program may be recorded in a recording medium readable by the image presentation device 1 and the image presentation device 2. When such a recording medium is used, the program can be installed in the image presentation device 1 and the image presentation device 2. The recording medium on which the program is recorded may be a non-transitory recording medium. Examples of the non-transitory recording medium include, but are not limited to, a CD-ROM, a DVD-ROM, and a universal serial bus (USB) memory. The program may be downloaded from an external device via a network.

With regard to the embodiments described above, the following supplementary items are further disclosed.

### Item 1

An image presentation device for presenting an image of a user, the device including:
a camera that captures images of a plurality of users; and
a controller that processes the captured images with an effect, alternately switches between the captured images of the plurality of users and the processed images, and displays them on a display.

### Item 2

The image presentation device as set forth in Item 1, wherein the controller generates a composite image in which the captured image of the user and the processed image are alternately switched between and presented, and combines the composite image for the plurality of users.

### Item 3

The image presentation device as set forth in Item 1 or 2, wherein the controller allows the user to select the effect to be used for image processing.

### Item 4

The image presentation device as set forth in Item 3, wherein the controller generates a plurality of effect images each indicating an effect.

### Item 5

An image presentation method for presenting an image of a user, the method including:
by an image presentation device,
capturing images of a plurality of users;
processing the captured images with an effect; and
alternately switching between the captured images of the plurality of users and the processed images and
   displaying them on a display.

### Item 6

A non-transitory storage medium that stores a program capable of being executed by a computer, the non-transitory storage medium causing the computer to function as the image presentation device as set forth in any one of Items 1 to 4.

Although the embodiments have been described as representative examples, it is apparent to those skilled in the art that many modifications and substitutions can be made within the spirit and scope of the present disclosure. Therefore, it should be understood that the present invention is not limited by the embodiments above, and various modifications or changes can be made without departing from the scope of the claims. For example, a plurality of configuration blocks illustrated in the configuration diagrams of the embodiments can be combined into a single block, or alternatively, a single configuration block can be divided into several sub-blocks.

### REFERENCE SIGNS LIST

1, 2, 3 Image presentation device
4 Display device (display)
11 Image capturing unit
12 Image processing unit
13 Image composition unit
14 Image combining unit
15 Effect selection unit
100 Computer
110 Processor
120 ROM
130 RAM
140 Storage
150 Input unit
160 Output unit
170 Communication interface (I/F)
180 Bus

1. An image presentation device for presenting an image of a user, the device comprising:
image capturing circuitry configured to capture images of a plurality of users;
image processing circuitry configured to process the captured images with an effect; and
image combining circuitry configured to alternately switch and output the captured images of the plurality of users and the processed images.

2. The image presentation device according to claim 1, further comprising:
image composition circuitry configured to generate and output a composite image in which the captured image of the user and the processed image are alternately switched,
wherein the image combining circuitry is configured to combine the composite image for the plurality of users.

3. The image presentation device according to claim 1, further comprising:
effect selection circuitry configured to allow the user to select the effect to be used for image processing.

4. The image presentation device according to claim 3, wherein the effect selection circuitry is configured to generate a plurality of effect images indicating effects, and to output an effect indicated by an effect image selected by the user to the image processing circuitry.

5. An image presentation method for presenting an image of a user, the method comprising:
by an image presentation device,
capturing images of a plurality of users;
processing the captured images with an effect;
alternately switching the captured images of the plurality of users and the processed images; and
displaying the captured images of the plurality of users and the processed images on a display device.

6. A program for causing a computer to function as the image presentation device according to claim 1.

7. The image presentation device according to claim 2, further comprising:
an image presentation device wherein the image presentation device alternatively displays the captured image of the user and the processed image.

8. The image presentation device according to claim 1, further comprising:
image synthesizing circuitry generates a synthesized image presented by alternately switching the captured image and the processed image and sequentially outputs the synthesized image of each of the plurality of users to the image combining circuitry.
